(19) United States
(12) Patent Application Publication
(10) Pub. No.: US 2011/0019269 A1
(43) Pub. Date: Jan. 27, 2011

(54) Protective Light Filters Having Customized Spectral Profiles

(75) Inventor: Carl W. Dirk, El Paso, TX (US)

Correspondence Address: FULBRIGHT & JAWORSKI L.L.P., 600 CONGRESS AVE., SUITE 2400, AUSTIN, TX, 78701, US

(73) Assignee: Board of Regents of the University of Texas System

(21) Appl. No.: 12/840,891

(22) Filed: Jul. 21, 2010

Related U.S. Application Data
(60) Provisional application No. 61/227,249, filed on Jul. 21, 2009.

(51) Int. Cl. G02B 5/20; G06F 17/50; G06F 17/10; G06F 7/60

(52) U.S. Cl. 359/359; 359/885; 359/361; 703/2

(57) ABSTRACT

Optical filters (e.g., sunglass lenses and/or window-tint films) having customized spectral profiles.

### RELATED APPLICATIONS

This application claims the benefit of U.S. Provisional Patent Application No. 61/227,249, filed Jul. 21, 2009, which is incorporated herein by reference in its entirety.

This application incorporates by reference each of: (1) U.S. patent application Ser. No. 10/688,200 entitled “Customizable Spectral Profiles for Filtering,” by Carl W. Dirk, which was filed on Oct. 17, 2003; (2) U.S. patent application Ser. No. 11/232,442 entitled “Illumination Sources and Customizable Spectral Profiles,” by Carl W. Dirk, which was filed on Sep. 21, 2005; and (3) U.S. patent application Ser. No. 12/466,589 entitled “Protective Light Filters and Illuminants Having Customized Spectral Profiles,” by Carl W. Dirk, which was filed on May 15, 2009.

### BACKGROUND

1. Field of the Invention

The present invention relates generally to optics, spectroscopy, and illumination sources. More particularly, but not by way of limitation, the present invention relates to customized spectral profiles and filters having customized spectral profiles. Representative embodiments relate to customized spectral profiles that, when incorporated into an optical filter (e.g., a sunglass lens), will reduce the light transmitted through the filter while maintaining acceptable color rendering, and/or to provide enhanced protection to the eye.

2. Background Information

It is known that the quality of light falling upon an eye of a person may eventually damage the eye and/or lead to degraded perception of light and/or color of the eye (e.g., degraded vision). Additionally, when light hitting the eye of a person is bright, it may cause the person to squint and may eventually increase the number and/or depth of wrinkles and the like.

One of the most common tools for reducing such degradations in vision is to wear sunglasses when exposed to sunlight. While known sunglasses may provide some reduction in transmitted ultraviolet (UV) light, such known sunglasses generally do not reduce visible light in an appreciable degree or in such a way as to preserve natural or acceptable color rendering.

One of the most common methods to minimize degradation is to minimize the amount of ultraviolet and/or infrared radiation that impacts the eye (e.g., by way of sunglasses, window-tint film, and the like). Although this may be somewhat effective, it generally does not prevent degradation that may be caused by visible wavelengths of light (e.g., by photons that do not significantly affect color rendering). In other words, known solutions generally do not block visible-light photons that do not contribute to color perception. Put yet another way, today's solutions are not equipped to render only the necessary portions of photometric light-transmit visible-light photons that significantly affect color perception (e.g., light necessary for proper color rendering) while blocking photons unneeded for this task.

U.S. Pat. No. 6,309,753, filed Aug. 9, 1999, and issued Oct. 30, 2001, to Grossman et al., is incorporated by reference to the extent it may disclose certain materials and/or compositions that may be useful in manufacturing certain embodiments of the present filters and/or illuminants.

These issues with today's technology are not meant to constitute an exhaustive list nor to limit the applications or features in this disclosure. Rather, they illustrate by example a need for the customized spectral profiles, filters, and illuminants of this disclosure.

### SUMMARY OF THE INVENTION

The present disclosure includes various embodiments of methods, customized spectral profiles, and filters having customized spectral profiles. Various embodiments of the present disclosure may be described with reference to a source illuminant and/or a reference illuminant. Source and/or reference illuminants can comprise any suitable illuminants, such as, for example, lamp or bulb illuminants (e.g., a D65 lamp, etc.), theoretical reference illuminants (e.g., Standard D65, etc.), sunlight, candles, oil lamps, and/or any other suitable illuminants.

Some embodiments of the present optical filters comprise: a substrate; and one or more filter layers coupled to the substrate, at least one of the one or more filter layers in direct contact with the substrate; where the optical filter is configured to reduce luminance by between about 80% and about 90% and to have a color rendering index (CRI) of more than about 80 relative to an unfiltered reference illuminant. In some embodiments, the unfiltered reference illuminant is sunlight. In some embodiments, the unfiltered reference illuminant is a Standard D65 illuminant. In some embodiments, the optical filter is configured to have a CRI of between about 85 and about 95. In some embodiments, the optical filter is configured to have a CRI of more than about 90. In some embodiments, the optical filter is configured to reduce luminance by about 85%.

In some embodiments, the optical filter is configured to transmit at least some portion of light having a wavelength above about 400 nanometers (nm) and to substantially block light having a wavelength below about 400 nm. In some embodiments, the optical filter is configured to transmit at least some portion of light having a wavelength below about 750 nanometers (nm) and to substantially block light having a wavelength above about 750 nm. In some embodiments, the optical filter is configured to: (a) block at least 95% of light having a wavelength below about 410 nanometers; (b) block at least 95% of light having a wavelength above about 710 nm; (c) block between about 70% and about 90% light having a wavelength between about 510 nm and about 550 nm and between about 590 nm and about 630 nm; and (d) block less than about 20% of at least one wavelength of light having a wavelength between about 450 nm and about 470 nm. In some embodiments, the optical filter is configured to block at least 95% of at least one wavelength of light having a wavelength between about 460 nm and about 490 nm. In some embodiments, the optical filter is configured to transmit between about 20% and about 30% of at least one wavelength of light having a wavelength between about 520 nm and about 540 mm. In some embodiments, the optical filter is configured to block between about 85% and about 95% of at least one wavelength of light having a wavelength between about 560 nm and about 580 nm. In some embodiments, the optical filter is configured to transmit between about 15% and about 25% of at least one wavelength of light having a wavelength between about 600 nm and about 620 nm.

Some embodiments of the present optical filters are configured to be coupled to a sunglass frame. Some embodiments of the present optical filters comprise a substantially rigid sheet suitable for a window.

Some embodiments of the present sunglasses comprise one or more of the present optical filters.

Some embodiments of the present methods of generating a customized spectral profile comprise: obtaining a reference spectrum for an unfiltered reference illuminant; generating a trial spectrum; calculating one or more optical indices of the trial spectrum; and generating a customized spectral profile by varying with a computer the trial spectrum to optimize the one or more optical indices of the trial spectrum relative to the reference spectrum. In some embodiments, the reference spectrum comprises a Standard D65 spectral profile. In some embodiments, the reference spectrum is the spectral profile of a an illuminant having a spectral profile substantially similar to the Standard D65 spectral profile. In some embodiments, calculating one or more optical indices comprises calculating the reduction in luminance and the color rendering index (CRI) of the trial spectrum relative to the reference spectrum. In some embodiments, varying the trial spectrum to maximize the reduction in luminance of the trial spectrum while simultaneously maximizing the CRI of the trial spectrum. In some embodiments, generating a customized spectral profile comprises: selecting a target reduction in luminance of the trial spectrum; and varying the trial spectrum to maximize the CRI of the customized trial spectrum at the target reduction in luminance. In some embodiments, generating a customized spectral profile comprises: selecting a target CRI of the trial spectrum; and varying the trial spectrum to maximize the reduction in luminance of the trial spectrum at the target CRI.

Any embodiment of any of the present methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Details associated with the embodiments described above and others are presented below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 depicts a flowchart illustrating a method of generating an optical filter having a customized spectral profile.

FIGS. 2A and 2B depict flowcharts illustrating alternatives for an optimizing step of the method of FIG. 1.

FIG. 3 depicts a customized spectral profile.

FIG. 4 depicts a pair of sunglasses having a customized spectral profile.

### DESCRIPTION OF ILLUSTRATIVE EMBODIMENTS

The term “coupled” is defined as connected, although not necessarily directly, and not necessarily mechanically; two items that are “coupled” may be integral with each other. The terms “a” and “an” are defined as one or more unless this disclosure explicitly requires otherwise. The terms “substantially,” “approximately,” and “about” are defined as largely but not necessarily wholly what is specified, as understood by a person of ordinary skill in the art.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a filer that “comprises,” “has,” “includes” or “contains” one or more elements possesses those one or more elements, but is not limited to possessing only those elements. Likewise, a method that “comprises,” “has,” “includes” or “contains” one or more steps possesses those one or more steps, but is not limited to possessing only those one or more steps. For example, in a filter that comprises a substrate, a plurality of first filter layers, and a plurality of second filter layers, the filter includes the specified elements but is not limited to having only those elements. For example, such a method could also include a plurality of third filter layers.

Further, a device or structure that is configured in a certain way is configured in at least that way, but it can also be configured in other ways than those specifically described.

Through methods such as, for example, the methods described in the Dirk patent applications incorporated by reference above, customized spectral profiles can be generated or developed to have desirable characteristics. Such customized spectral profiles can, for example, be incorporated into a filter (e.g., a filter can be formed or configured to have a customized spectral profile that is about equal to or substantially similar to the customized spectral profile.

A number of references, factors, and characteristics of illumination and/or spectra may be useful for characterizing the customized spectral profiles, filters, and/or illuminants of the present disclosure. A “reference illuminant” can include established theoretical references (e.g., standard A illuminant, standard D65 illuminant, standard F7 illuminant), and/or one or more actual illuminants (e.g., incandescent or fluorescent illuminants, such as are manufactured or distributed by Sylvania throughout the United States). For example, illuminants exist that have spectral profiles about equal to or substantially similar to the standard D65 spectrum. As will be understood by those of ordinary skill in the art standard D65 is a well-known theoretical reference illumination spectrum representing daylight.

“Color Difference” refers to a just-perceptible difference in color, i.e., : ΔE=DE=1. Color difference can be determined using: (1) the pre-L*a*b* color difference formula which is based on UVW in the 106-CIE Yuv coordinate system Pre-Lab Color Difference is UVW in the 106-CIE Yuv coordinate system; (2) the DE76 color difference formula; (3) the DE94 color difference formula, and/or the DE00 color difference formula.

“Color rendering” refers to the accuracy with which colors are rendered by one illuminant relative to a reference illuminant. Color Rendering Index (CRI) is an indication of how well the illuminant is matched to the reference illuminant, with a CRI≡100 being a perfect match of the illuminant to the reference illuminant. For example, the CRI of filtered sunlight (e.g., sunlight filtered through an optical filter such as a sunglass lens) can be calculated relative to unfiltered sunlight (which would act as the reference illuminant), or could be calculated relative to a theoretical reference illuminant (e.g., Standard D65). CRI relates to color difference such that 4.6 CRI units are about equivalent to DE=1 color difference unit. In this way, just-perceptible changes in CRI occur between the following points: 100, 95.4, 90.8, 86.2, 81.6, and so on (even below zero in some instances). CRI can be determined by calculating color difference between the illuminant and the reference illuminant and applying adaptation models to determine the appropriate perceived CRI. CRI can be determined using CIE 13.3.

“Luminance” generally refers to a photometric measure of the luminous intensity per unit area of light traveling in a given direction. As used in this disclosure, “luminance” refers to perceptible wavelengths of light (e.g., of a visible sensation to humans) averaged over the visible spectrum of between about 360 nm and about 830 nm, weighted by the photopic function. As such, reduction in luminance of an optical filter may be described as the luminance of light from a reference illuminant filtered by the optical filter relative to the luminance of unfiltered light from the reference illuminant.

“Luminosity” or “luminous intensity” refers to perceived brightness of illumination. Luminosity can, for example, be calculated using (1) the Standard Vision Theory model in which luminosity is determined from luminance (Y), which is itself derived from the Photopic function; (2) the Helmholtz-Kohlrausch model in which luminosity may be determined from luminance (Y) and chromaticity (x,y); and/or (3) the opponent color theory in which luminosity may be determined from L*a*b* coordinates. Where reference is made to reducing luminance, it may, additionally or alternatively, include reducing luminosity and/or reducing perceived brightness (theoretical and/or experimental).

Some of the characteristics of spectral profiles and filters having customized spectral profiles may be described in this disclosure without reference to a reference illuminant; it will be understood by those of ordinary skill of the art, however, that certain of the characteristics described may require or be best understood in context of a filter having the customized spectral profile or configured (e.g., by way of one or more filter layers) to incorporate the customized spectral profile, and/or may by nature be defined relative to an unfiltered reference illuminant.

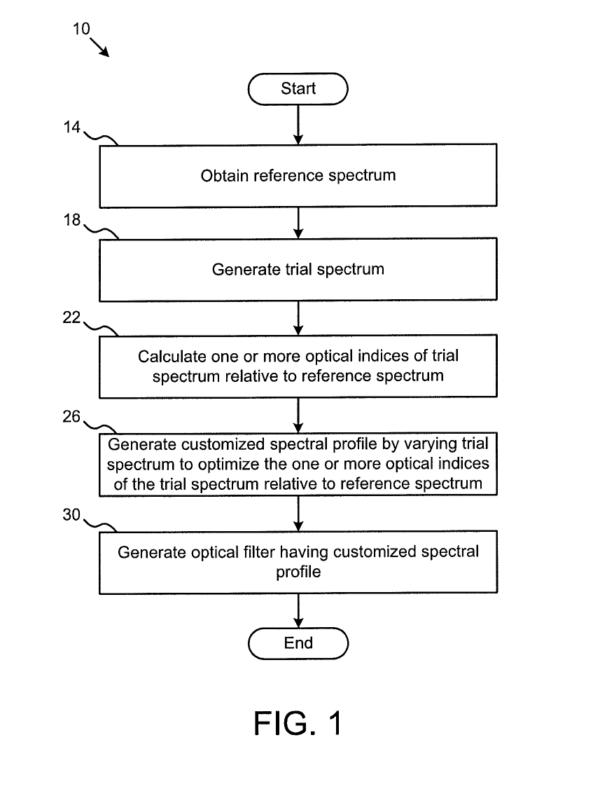

Referring now to the drawings, and more particularly to FIG. 1, a flowchart is shown of a method 10 of generating a customized spectral profile. In the embodiment shown, the method comprises a step 14 comprising obtaining a reference spectrum, a step 18 comprising generating a trial spectrum, a step 22 comprising calculating one or more optical indices of the trial spectrum relative to the reference spectrum, and a step 26 comprising generating a customized spectral profile by varying the trial spectrum to optimize the one or more optical indices of the trial spectrum relative to reference spectrum.

In step 14, obtaining a reference spectrum can include obtaining a known reference spectrum (e.g., Standard D65 spectrum), and/or can include experimentally obtaining an unfiltered reference spectrum (e.g., measuring unfiltered natural sunlight or measuring an unfiltered illuminant having a spectral profile about equal to or substantially similar to that of standard D65). Obtaining a reference spectrum can also include computationally or experimentally illuminating one or more test objects, such as, for example, with sunlight or the Standard D65 spectrum. For example, when color rendering index (CRI) is to be determined for the trial spectrum using the CIE 13.3 method, the one or more test objects can include the standard Munsell 8 test set.

In step 18, generating a trial spectrum can include entering values for a trial spectrum in tabular form, graphically selecting values for a trial spectrum, clicking and dragging a line or curve to selected places on a chart or graph (e.g., on a computer display via an input device such as a mouse). In step 22, calculating one or more optical indices of the trial spectrum can comprise calculating the CRI of the trial spectrum relative to the reference spectrum (e.g., the CRI of the reference spectrum filtered by a filter having the trial spectrum), and/or can comprise calculating the reduction in luminance of the trial spectrum relative to the reference spectrum (e.g., the reduction in luminance of the reference spectrum filtered by a filter having the trial spectrum).

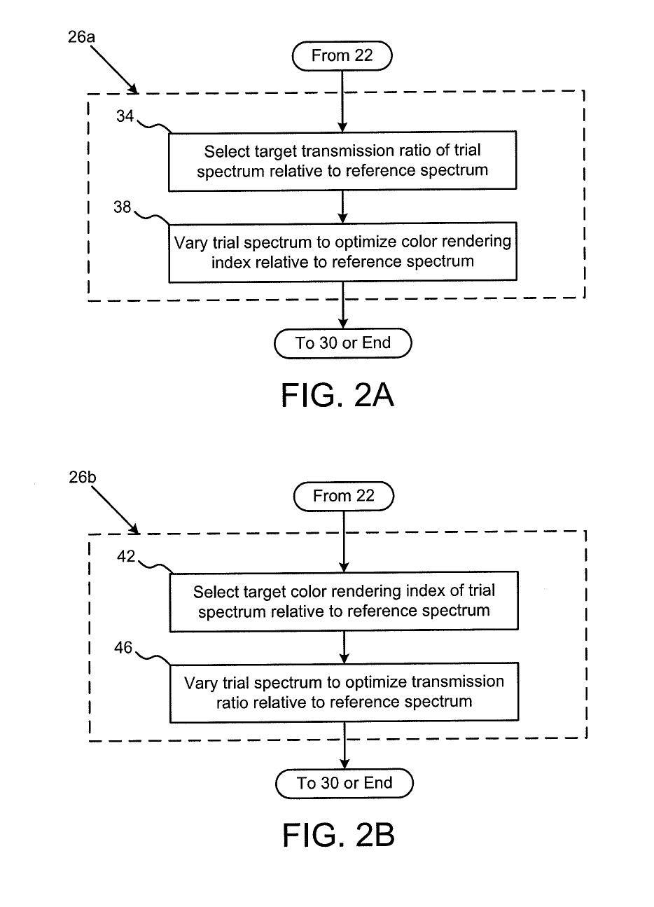

In step 26, generating a customized spectral profile can comprise varying the trial spectrum to optimize the one or more optical indices of the trial spectrum relative to the reference spectrum. For example, in one embodiment, generating a trial spectrum can comprise varying the trial spectrum to maximize the reduction in luminance of the trial spectrum while simultaneously maximizing the CRI of the trial spectrum. In another embodiment, illustrated as step 26a of FIG. 2A, generating a trial spectrum can comprise: a substep 34 of selecting a target reduction in luminance of the trial spectrum (e.g., equal to, greater than, or between any of, about 70%, 75%, 80%, 85%, 90%, 95%, or any other percentage between 5% and 100%); and a substep 38 of varying the trial spectrum to maximize the CRI of the customized trial spectrum at the target reduction in luminance. In yet another embodiment, illustrated as step 26b of FIG. 2B, generating a trial spectrum can comprise: a substep 42 of selecting a target CRI (e.g., equal to, greater than, or between any of, about: 85, 86, 87, 88, 89, 90, 91, 92, 93, 94, 95, 96, 97, 98, 99, or any other value between 50 and 100) of the trial spectrum; and a substep 46 of varying the trial spectrum to maximize the reduction in luminance of the trial spectrum at the target CRI.

In the embodiment shown, method 10 can further comprise a step 30 comprising generating an optical filter (e.g., a sunglass lens, window-tint film, a substantially rigid sheet such as plate glass for windows and the like, etc.). Such optical filters can be generated or manufactured by any suitable methods, such as, for example, by depositing one or more filter layers on a substrate with magnetron-sputtering techniques, molecular beam epitaxy, topotaxy, pulsed laser deposition, cathodic arc deposition, thermal evaporation, plating, chemical solution deposition, chemical vapor deposition, plasma enhanced chemical vapor deposition, and/or by any other suitable methods, techniques, or filter configurations.

Embodiments of filters disclosed herein can comprise any suitable materials. For example, a filter can comprise a substrate including glass (e.g., borosilicate glass), polycarbonate, plastic, polymer, etc. An example of a suitable substrate (at least for certain filter layer materials is 8511 Glass manufactured by Corning Corporation, U.S.A. In some embodiments, the substrate (e.g., 8511 Glass) is configured to transmit light having a wavelength above about 400 nanometers (nm) and to substantially block light having a wavelength below about 400 nm. By way of further examples, filter layers coupled to the substrate can comprise Niobium (Nb), such as, for example, Niobium Pentoxide (Nb₂O₅); and/or comprise Silicone (Si), such as, for example, Silicone Oxide (Si0₂).

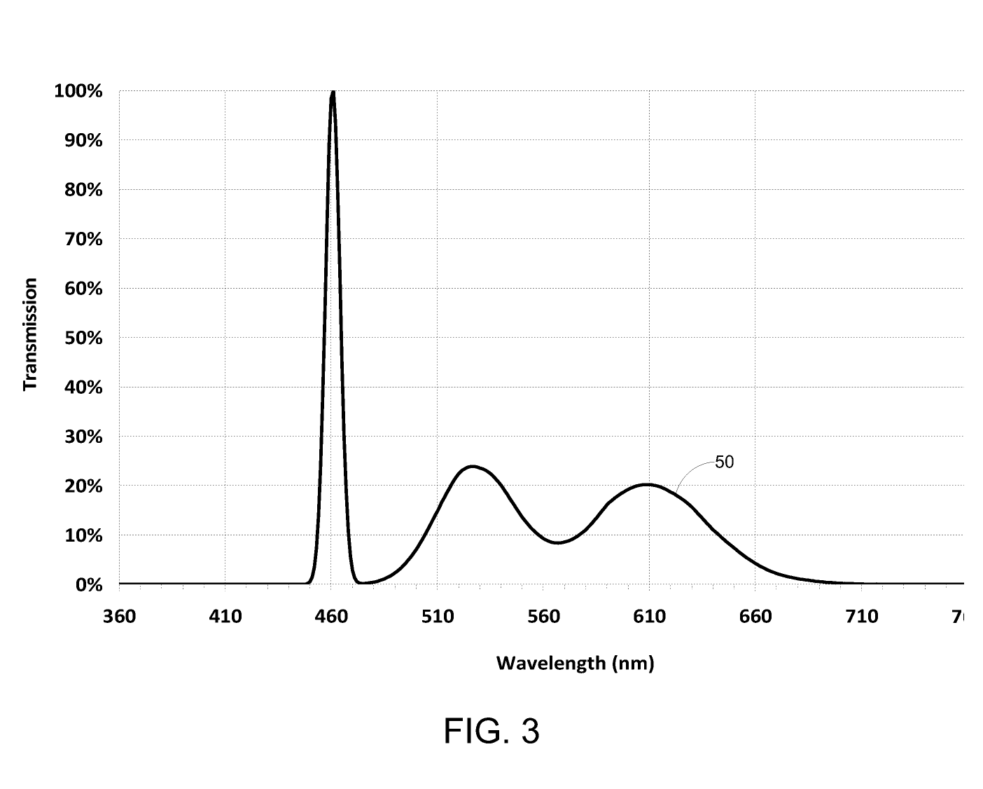

FIG. 3 depicts one example of a customized spectral profile 50 developed (optimized) to have desirable optical characteristics for sunglass lenses and/or window-tint films. While customized spectral profile 50 is described in this disclosure as being configured to have certain characteristics (e.g., CRI, reduction in luminance, block or transmit a percentage of light, etc.), it should be understood that customized spectral profile 50 is configured such that an optical filter having a spectral profile about equal to or substantially similar to customized spectral profile 50 will have the described optical characteristics (e.g., relative to an unfiltered illuminant). Some of the optical characteristics of the customized spectral profile 50 may be described without reference to a reference illuminant (e.g., sunlight or D65 spectrum); it will be understood by those of ordinary skill of the art, however, that certain of the characteristics described may by nature be defined relative to an unfiltered illuminant. Customized spectral profile 50 shown is configured to have a reduction in luminance of about 85% relative to unfiltered Standard D65 illumination (spectrum). For example, a filter having customized spectral profile 50 optically coupled to a D65 illuminant at an incidence angle of zero degrees (perpendicular to the filter) will reduce the luminance of transmitted light by 85%.

Customized spectral profile 50 is configured to reduce luminance by between about 80% and about 90% (e.g., equal to, greater than, or between, any of about: 80%, 81%, 82%, 83%, 84%, 85%, 86%, 87%, 88%, 89%, 90%). Customized spectral profile 50 is also configured to have a color rendering index (CRI) of more than about 80 (e.g., between about 85 and about 95, more than about 90, etc.) relative to an unfiltered reference illuminant. More particularly, in the embodiment shown, customized spectral profile 50 is configured to reduce luminance by about 85% and to have a CRI of about 93 (calculated with CIE 13.3 method). As shown, customized spectral profile 50 is configured to transmit at least some portion of light having a wavelength above about 400 nanometers (nm) and to substantially block light having a wavelength below about 400 nm. In the customized spectral profile, customized spectral profile 50 is also configured to transmit at least some portion of light having a wavelength below about 750 nanometers (nm) and to substantially block light having a wavelength above about 750 nm.

In the embodiment shown, customized spectral profile 50 is also configured to: (a) block at least 95% of light having a wavelength below about 410 nanometers; (b) block at least 95% of light having a wavelength above about 710 nm; (c) block between about 70% and about 90% light having a wavelength between about 510 nm and about 550 nm and between about 590 nm and about 630 nm; and (d) block less than about 20% of at least one wavelength of light having a wavelength between about 450 nm and about 470 nm. Customized spectral profile 50 can also be configured to block at least 95% of at least one wavelength of light having a wavelength between about 460 nm and about 490 nm. Customized spectral profile 50 can also be configured to transmit between about 20% and about 30% of at least one wavelength of light having a wavelength between about 520 nm and about 540 nm. Customized spectral profile 50 can also be configured to block between about 85% and about 95% of at least one wavelength of light having a wavelength between about 560 nm and about 580 nm. Customized spectral profile 50 can also be configured to transmit between about 15% and about 25% of at least one wavelength of light having a wavelength between about 600 nm and about 620 nm.

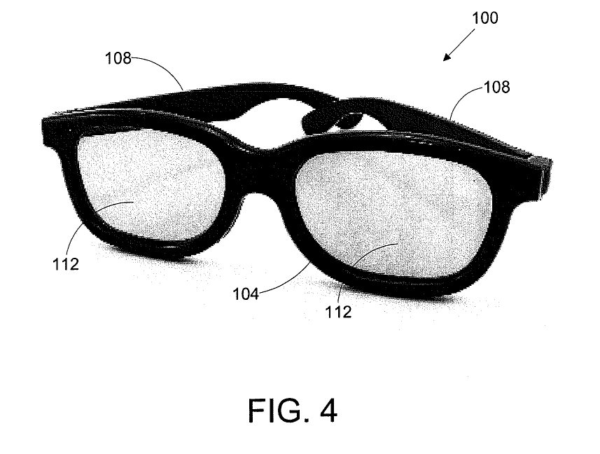

Referring now to FIG. 4, one example is shown of sunglasses 100. Sunglasses 100 comprise a frame 104, two arms 108, and two lenses 112 (optical filters). As shown, lenses 112 (optical filters) are configured to be coupled to (and are shown coupled to) sunglass frame 104. Lenses 112 can be configured to have a spectral profile that is about equal to or substantially similar to a customized spectral profile having any of the features described above. In other embodiments, frame 104 and lenses 112 can be integral (e.g., a single lens spanning both eyes can be coupled directly to arms 108).

Any of various filters can be configured to have a customized spectral profile and/or other characteristics that are substantially similar to the experimental customized spectral profile and/or other characteristics of the customized spectral profile described above.

The various illustrative embodiments of devices, systems, and methods described herein are not intended to be limited to the particular forms disclosed. Rather, they include all modifications, equivalents, and alternatives falling within the scope of the claims.

The claims are not intended to include, and should not be interpreted to include, means-plus- or step-plus-function limitations, unless such a limitation is explicitly recited in a given claim using the phrase(s) “means for” or “step for,” respectively.

1. An optical filter comprising:
a substrate;
one or more filter layers coupled to the substrate, at least one of the one or more filter layers in direct contact with the substrate;
where the optical filter is configured to reduce luminance by between about 80% and about 90% and to have a color rendering index (CRI) of more than about 80 relative to an unfiltered reference illuminant.

2. The optical filter of claim 1, where the unfiltered reference illuminant is sunlight.

3. The optical filter of claim 1, where the unfiltered reference illuminant is a Standard D65 illuminant.

4. The optical filter of claim 1, where the optical filter is configured to have a CRI of between about 85 and about 95.

5. The optical filter of claim 4, where the optical filter is configured to have a CRI of more than about 90.

6. The optical filter of claim 1, where the optical filter is configured to reduce luminance by about 85%.

7. The optical filter of claim 1, where the optical filter is configured to transmit at least some portion of light having a wavelength above about 400 nanometers (nm) and to substantially block light having a wavelength below about 400 nm.

8. The optical filter of claim 1, where the optical filter is configured to transmit at least some portion of light having a wavelength below about 750 nanometers (nm) and to substantially block light having a wavelength above about 750 nm.

9. The optical filter of claim 1, where the optical filter is configured to:
(a) block at least 95% of light having a wavelength below about 410 nanometers;
(b) block at least 95% of light having a wavelength above about 710 nm;
(c) block between about 70% and about 90% light having a wavelength between about 510 nm and about 550 nm and between about 590 nm and about 630 nm; and
(d) block less than about 20% of at least one wavelength of light having a wavelength between about 450 nm and about 470 nm.

10. The optical filter of claim 9, where the optical filter is configured to block at least 95% of at least one wavelength of light having a wavelength between about 460 nm and about 490 nm.

11. The optical filter of claim 10, where the optical filter is configured to transmit between about 20% and about 30% of at least one wavelength of light having a wavelength between about 520 nm and about 540 nm.

12. The optical filter of claim 11, where the optical filter is configured to block between about 85% and about 95% of at least one wavelength of light having a wavelength between about 560 nm and about 580 nm.

13. The optical filter of claim 12, where the optical filter is configured to transmit between about 15% and about 25% of at least one wavelength of light having a wavelength between about 600 nm and about 620 nm.

14. The optical filter of claim 1, where the optical filter is configured to be coupled to a sunglass frame.

15. The optical filter of claim 1, where the optical filter comprises a substantially rigid sheet suitable for a window.

16. A pair of sunglasses comprising:
one or more optical filters of claim 1.

17. A method of generating a customized spectral profile, comprising:
obtaining a reference spectrum for an unfiltered reference illuminant;
generating a trial spectrum;
calculating one or more optical indices of the trial spectrum;
generating a customized spectral profile by varying with a computer the trial spectrum to optimize the one or more optical indices of the trial spectrum relative to the reference spectrum.

18. The method of claim 17, where the reference spectrum comprises a Standard D65 spectral profile.

19. The method of claim 18, where the reference spectrum is the spectral profile of a an illuminant having a spectral profile substantially similar to the Standard D65 spectral profile.

20. The method of claim 17, where calculating one or more optical indices comprises calculating the reduction in luminance and the color rendering index (CRI) of the trial spectrum relative to the reference spectrum.

21. The method of claim 20, where generating a customized spectral profile comprises:
varying the trial spectrum to maximize the reduction in luminance of the trial spectrum while simultaneously maximizing the CRI of the trial spectrum.

22. The method of claim 20, where generating a customized spectral profile comprises:
selecting a target reduction in luminance of the trial spectrum; and
varying the trial spectrum to maximize the CRI of the customized trial spectrum at the target reduction in luminance.

23. The method of claim 20, where generating a customized spectral profile comprises:
selecting a target CRI of the trial spectrum; and
varying the trial spectrum to maximize the reduction in luminance of the trial spectrum at the target CRI.
